(19) United States
(12) Patent Application Publication
(10) Pub. No.: US 2018/0368617 A1
(43) Pub. Date: Dec. 27, 2018

(54) Charcoal Grilling Insert for Pellet Barbecues

(71) Applicant: Klaus Karl Allmendinger, San Juan Capistrano, CA (US)

(72) Inventor: Klaus Karl Allmendinger, San Juan Capistrano, CA (US)

(21) Appl. No.: 15/632,354

(22) Filed: Jun. 25, 2017

(51) Int. Cl. A47J 37/07

(52) U.S. Cl. CPC A47J 37/0704; A47J 37/079; A47J 37/0754; A47J 37/0786

(57) ABSTRACT

A grill box insert and grill insert controller for attaching to a pellet barbecue. The grill box insert has an open top, and an opening on the bottom for placement directly over a pellet barbecue's fire pot. The grill box insert has within it, a burn plate, upon which charcoal is placed. A cooking grate temperature sensor may be added to detect the temperature near the charcoal and grill box insert burn plate. The grill insert controller is wired such that it is capable of disrupting power to the pellet barbecue controller, directly controlling the pellet barbecue's electric combustion fan and monitoring the pellet barbecue's electrically heated igniter.

### BACKGROUND OF THE INVENTION

### Field of the Invention

This invention relates generally to a pellet-burning barbecues, and more particularly to a grilling insert for use with such barbecues.

### Description of the Related Art

Grilling or broiling in the context of this invention is the exposure of food (typically meat or meat products) to intense infrared radiation. During this process, the sugars on the surface of the food items caramelize, and exposed edges of the food to become charred, producing the typical grilled taste. In addition, a chemical reaction occurs between protein amino acids and reducing sugars, the so-called Maillard reaction, which causes browning of the food surfaces and contributes to the distinctive flavor of grilled food. Grilling is most often used for food items of small thermal mass, like kebabs, small seafood items like shrimp or scallops, sausages, hamburgers and for steaks where the externally applied heat travels quickly to the interior to cook them. Large thermal mass food items are not usually grilled, but barbecued with lower heat input to allow enough time for the externally applied heat to travel to the food interior to reduce the thermal gradient between exterior and interior.

The infrared radiation for grilling can be produced by electrical infrared heaters, glowing charcoal, wood coals, or gas infrared heaters. Grilling typically completes in minutes, compared to barbecuing, roasting or baking, processes often taking hours to complete.

Conventional gas grills, fueled by natural gas, propane, or butane, are constructed such that metal bars are disposed above the gas burners and heated by the burning gas. Electric broilers and glowing charcoal at grilling temperatures and the burners of infrared grills may have surface temperatures of up to 2000° C. (2273° K), while the metal bars in a conventional gas grill only reach temperatures of 500-600° C. In addition, gaseous fuels like natural gas (primarily methane, CH4) and propane (C3H8) are high hydrogen content fuels. The hydrogen content of those fuels is converted to H2O, water vapor, during the burn process. This water vapor has a high latent heat content that, when these vapors condense on the food item surfaces, produce an effect like ‘steaming’, which reduces or delays the Maillard reaction.

The Stefan-Boltzmann law states that the radiation energy radiated by a hot body increases with the 4th power of the temperature in ° K. Therefore, the radiation energy of glowing charcoal at high temperatures can be more than times higher than for example given off by the metal bars of a conventional gas grill.

Compared to an electric or gas grill, the combustion products of charcoal or wood coal grills also contain gaseous aromatic phenolic compounds that impart additionally a pleasant charcoal or wood fired taste and smell to the grilled food items, which is desired by many grilling aficionados. However, charcoal grills are inconvenient to operate because, compared to other types of grills, complicated and lengthy ignition procedures have to be followed and relatively large amounts of fuel are needed. The required combustion air is drawn through the coal layer by natural convection, and these coals stay hot for a long time after the grilling process is over while the coals burn slowly to ashes.

Manufacturers of pellet barbecues, which are fired by compressed hardwood sawdust pellets, and therefore are thought to also produce the aromatic phenolic compounds associated by burning wood, have tried to incorporate ‘grilling’ capability in their barbecues by disposing metal bars above the fire pot of a pellet grill. The schematic cross section of a typical pellet grill is shown in FIG. 1.

Pellet barbecues aka pellet grills or pellet smokers were invented in 1985 by Joe Traeger and patented in 1987 (U.S. Pat. No. 4,823,684). In a pellet barbecue (see schematic cross section FIG. 1) wood pellets, comprised of highly compressed hardwood sawdust, are transported from a pellet hopper 1 by a motorized auger 2 to a flat bottomed cylindrical fire pot 3, disposed in a cooking chamber 4. Air is forced by an electric combustion fan 5 through an air channel 6 to the fire pot 3 where the air enters the fire pot through holes in its cylindrical walls.

The pellets in the fire pot are ignited by an electrically heated igniter 9, or, if pellets are already burning in the fire pot 3, by the burning pellets in the fire pot 3.

The resulting combustion gases are deflected by a one or more heat deflector plates 7 or baffles to flow evenly through the cooking chamber 4. The heat deflector plates are typically removable to facilitate cleaning out of the solid combustion products from the bottom of the pellet barbecue cooking chamber 4. Food items are placed on the cooking grate 12. Finally, the resulting combustion gases and excess air are exhausted through the exhaust port 8.

In grilling configuration, FIG. 2 the heat deflector plate 7 is replaced by an arrangement of metal bars, such as angled bars 20 in this example, which are heated by the hot combustion gases from the fire pot 3.

Because the fire pot has only a small cross section area, typical diameter 7-8 cm, the metal bars 20 can only cover a small area and reach only a relatively low temperature, comparable to conventional gas grills, and is insufficient for the intense infrared radiation desired for grilling.

### BRIEF SUMMARY OF THE INVENTION

In a preferred embodiment, a conventional wood pellet barbecue is fitted with a grill box insert in order to significantly improve the ability of the conventional wood pellet barbecue to grill food. The grill box insert comprises of an open top, and an opening in the center bottom for attaching directly to the fire pot of the conventional wood pellet barbecue. Inside the grill box insert is a burn plate, and charcoal is placed above the burn plate. The heat from the burning of the wood pellets in the fire pot heats and ignites the charcoal. There is an optional cooking grate temperature sensor placed near the cooking grate to determine the heat near the cooking grate and food items placed on the cooking grate.

A grill insert controller is utilized to complement the pellet barbecue controller to better control the conventional wood pellet barbecue's electric combustion fan and monitor the electrically heated igniter. The grill insert controller has a relay switch, when energized, will interrupt power to the pellet barbecue controller, and take over control of the electric combustion fan. The grill insert controller has specialized logic to handle temperature adjustments particular to grilling, which a pellet barbecue controller would not normally have.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a cross sectional view of the prior art.

FIG. 2 is a cross sectional view of the prior art.

FIG. 3 is a schematic view of a preferred embodiment of a grill insert controller.

FIG. 4 is a cross sectional view of a preferred embodiment of a grill box insert.

FIG. 5 is a cross sectional view of a pellet grill retrofitted with a preferred embodiment of a grill box insert.

FIG. 6 is a flow chart diagram.

### DETAILED DESCRIPTION

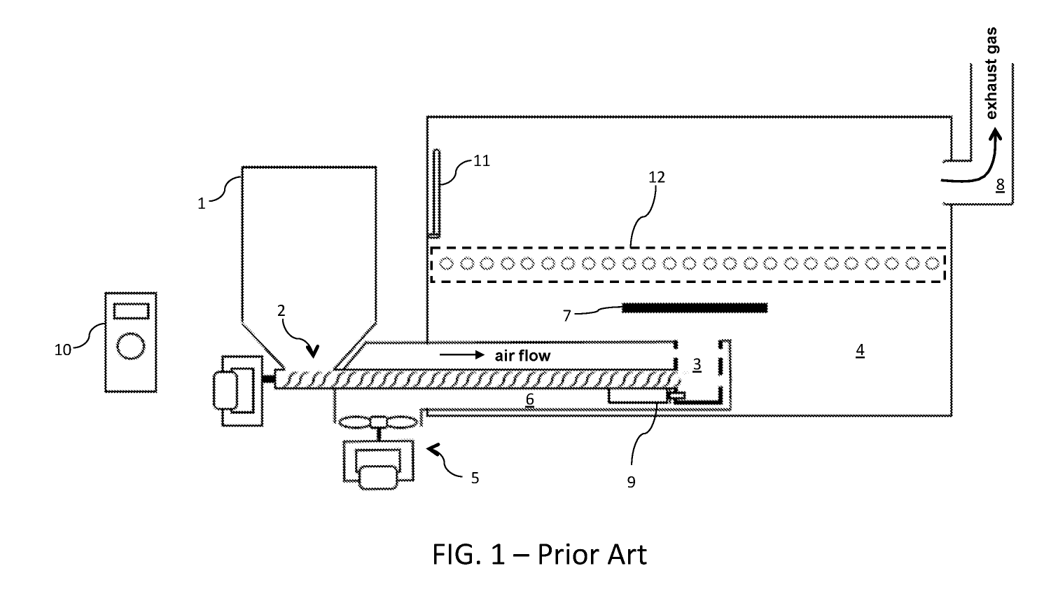

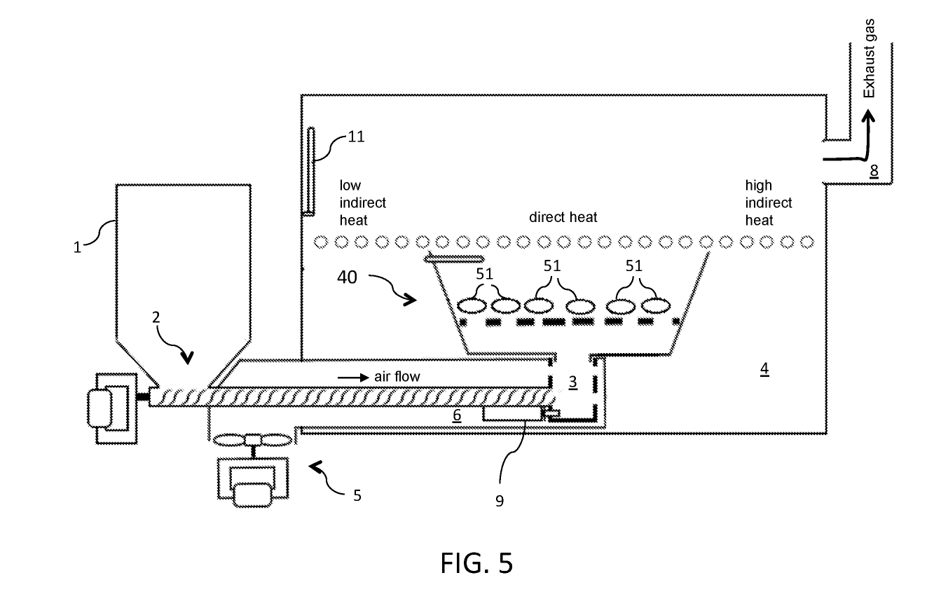

To allow the convenience of grilling with a gas or electric grill, while producing the intense radiation and the charcoal or wood fired taste and smell of a charcoal grill, this invention replaces temporarily the heat deflector plate 7 of a conventional pellet barbecue/smoker (FIG. 1) with a grill box insert (schematic cross section FIG. 4). The grill box insert assembly 40 may have angled or straight walls, and in a preferred embodiment is rectangular. The exact shape of the grill box insert assembly is not critical to the functionality, and as such, does not have to be a precise box shape. As with the original deflector plate 7 being replaced, the grill box insert 40 is situated between the fire pot 3 and the cooking grate 12 as shown in FIG. 5. In a preferred embodiment, the grill box insert assembly 40 is manufactured of steel sheet metal.

The grill box insert assembly 40 is open at the top and in an embodiment, has a circular opening in the center of the bottom surface. The circular opening further has attached to it a short, thin walled steel tube 43 with an outside diameter corresponding to the inside diameter of the fire pot 3. This allows for the grill box insert 40 to attach to the fire pot 3 and channel heat from the fire pot 3 to the interior of the grill box insert 40.

Further disposed in the grill box insert 40 is a perforated burn plate or grate 42. In a preferred embodiment, the burn plate 42 has openings, where the size of the openings of the burn plate or grate increase with distance from the center of the bottom opening, or alternately the spacing of the openings decreases with distance to the center of the bottom opening. The increase rate (or decrease rate of spacing) of the openings is chosen such that the gas or air exiting from the pellet grill fire box 3 and entering the grill box insert 40 through its bottom opening, cause an approximately constant gas flow through the burn plate or grate 42, independent of the distance from the gas entrance in the bottom side. In an embodiment of the grill box, guide vanes or channels are incorporated at the bottom surface of the burn plate or grate to further distribute the gas flow evenly.

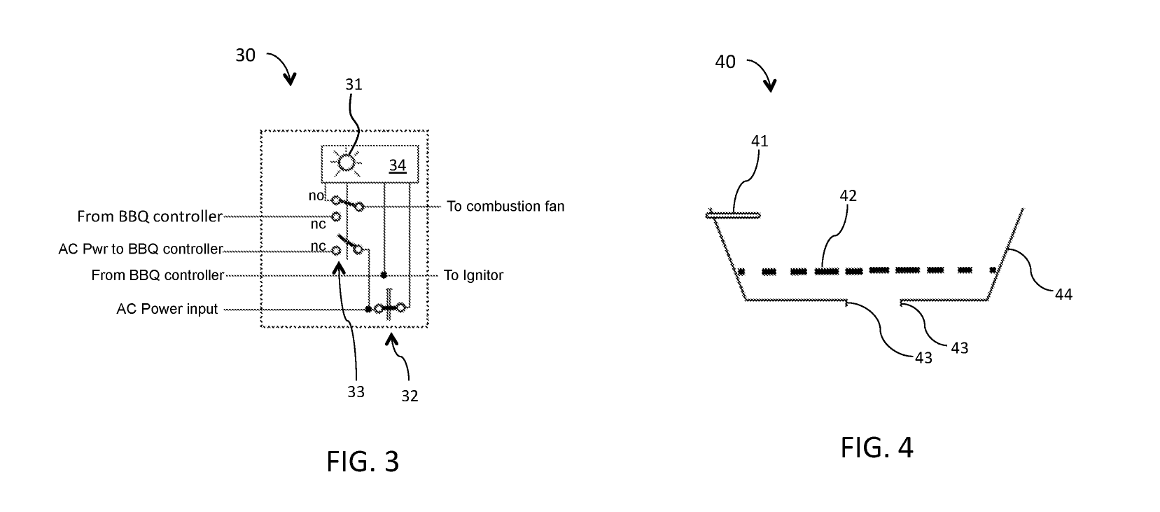

In FIG. 3, a grill insert controller 30, comprising of an electronic fan speed controller and computer logic 34, double pole/double throw (DPDT) relay switch 33, a power switch 32 and a user input device, such as a potentiometer 31. In a preferred embodiment, this is installed in the barbecue unit. The relay switch 33 is electrically inserted in the connection between the combustion fan 5 and the pellet barbecue controller 10, and in the connection between the AC power input of the pellet barbecue controller 10. A parallel connection to the connection between the pellet barbecue controller 10 and the pellet barbecue igniter 9 is also installed to allow the grill insert controller 30 to monitor igniter power. The grill insert controller 30 monitors the igniter to detect ignition of the pellets. Igniter power can be monitored by various means by the grill insert controller 30. For example, an optocoupler, whose LED is powered through a large enough resistor by drawing a small fraction of the igniter power, or a magnetic field sensor that detects the magnetic field generated by the igniter current, or a current transformer that creates an electrically insulated AC voltage when igniter power flows through it.

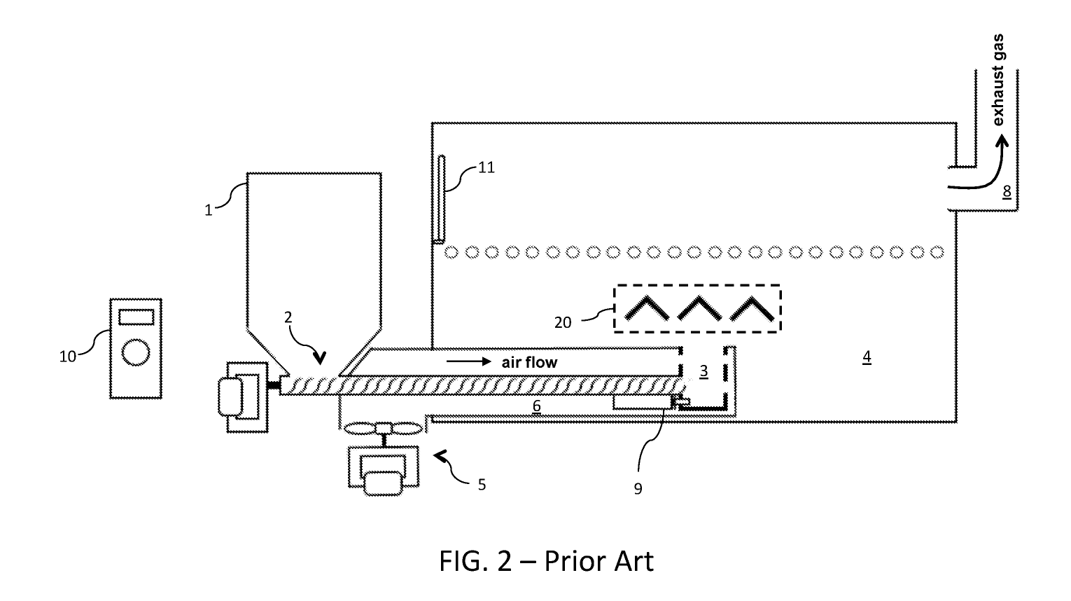

The relay switch 33 in FIG. 2 is shown in its energized (no, normally open) position. When not energized, the relay switch is in the nc, normally closed position. The relay switch can be implemented as a mechanical relay, or as one or more solid state relays (SSRs).

Optionally a cooking grate temperature sensor 41 is connected to the grill insert controller 30 to allow automatic closed loop control the grilling temperature and automatic switchover between pellet barbecue operation and grilling operation.

It is known to those skilled in the art that the functionality of this grill insert controller 30 and its hardware, including the switches, can also be incorporated as software functionality in a software and hardware implementation of a pellet barbecue controller.

To commence grilling, the user replaces the heat deflector plate 7 of the pellet barbecue with the grill box insert 40 as shown in FIG. 5 and switches the grill insert controller 30 on with the power switch 32. The grill controller relay switch 33 is initially in the default non-energized nc position. The user then places a single layer of charcoal briquettes 51 or pieces on the burn plate/grate 42 and switches the pellet barbecue on as if he would cook at high temperature with the pellet barbecue. The hot combustion gases exiting the fire pot 3 impinge on the bottom of the burn plate 42 and pass through the openings of the burn plate 42, igniting the charcoal briquettes 51 or pieces placed on top of the burn plate 42.

Typical pellet barbecues supply power to the igniter 9 during startup until the pellets are ignited. The pellet barbecue controller 10, depending on its ignition algorithm, either operates the igniter for a fixed, predetermined time or until the cooking chamber temperature sensor 11 detects a sufficient temperature rise. Once pellet ignition is detected by the pellet barbecue controller, the igniter is switched off.

Pellet barbecues typically feed far more air through the fire pot than is needed to supply oxygen to the burning wood pellets. The oxygen of the excess air is more than sufficient for the ignition charcoal in the path of the gases exiting the fire pot.

The grill insert controller logic 34 detects the point in time where the pellet barbecue controller 10 switches off the igniter 9. The grill insert controller logic 34 then waits for a predetermined time sufficient to ignite all the charcoal, or, if the grilling box is equipped with a cooking grate temperature sensor 41, until the heat from the burning charcoal has sufficiently increased the sensed temperature. It then energizes its relay switch 33, thereby interrupting power to the pellet barbecue controller 10, and connecting the pellet grill combustion fan 5 to the grill insert controller's fan speed controller 34. The grill temperature can then be adjusted by manipulating the air flow rate to the charcoal through controlling the combustion fan speed by the grill insert controller 30 as desired by the user by the setting of the user input device 31 of the grill insert controller 30.

If the grilling box insert 40 is optionally equipped with a cooking grate temperature sensor 41, the user input device 31 of the grill insert controller 30 can be used to set the desired cooking grate temperature and the grill insert controller's computer logic 34 can adjust the air flow rate of the combustion fan 5 accordingly.

If the grilling box insert 40 is optionally equipped with a cooking grate temperature sensor 41 and the grill controller 30 functionality is implemented as software function in the pellet barbecue controller 10, the pellet barbecue controller must also incorporate an input connection for the cooking grate temperature sensor 41, for example in the form of a conveniently placed socket installed in the wall of the pellet barbecue unit, into which the electrical plug connection of the cooking grate temperature sensor 41 will be plugged in by the user when he installs the grilling box insert 40 into the pellet barbecue, and unplugged by the user when the grilling box insert 40 is not used. The presence of a connection to a cooking grate temperature sensor 41 may then be detected by the pellet barbecue controller software and may be used to indicate to the pellet barbecue controller software that the user wishes it to invoke the software implementation of the grill controller 30 instead of normal barbecue operation. This functionality eliminates the need for the user to switch the pellet barbecue controller with software implemented grill controller 30 functionality to a special ‘grilling mode’ operation.

The temperature measurement of the cooking grate temperature sensor 41 can also be used by the grill insert controller 30 to signal the user (through for example a LED indicator) when it is time to add additional charcoal. For typical grilling operation only a very low fan speed is required to produce sufficient heat output of the charcoals. As the charcoal is consumed, the fan speed needs to increase to maintain a constant cooking grate temperature. When the fan speed required to maintain the desired cooking grate temperature is maxed out, additional charcoal needs to be added. Conveniently, this also results in a safe and fast burn-down function of the remaining coals, as, different to a conventional charcoal grill where the convective gas flow decreases the more coals are burned down, the combustion air flow during shutdown rises to the maximum fan speed, consuming the remaining coals faster and faster and the remaining coals are quickly burned off. The grill insert controller 30 may be equipped with an ambient air temperature sensor and can detect when the cooking grate temperature sensor 41 indicates a sufficiently small temperature difference to the ambient air, and then signal to the user that the coals have safely burned down, and the coal ashes can be safely be disposed, or the grilling box can be removed from the pellet barbecue.

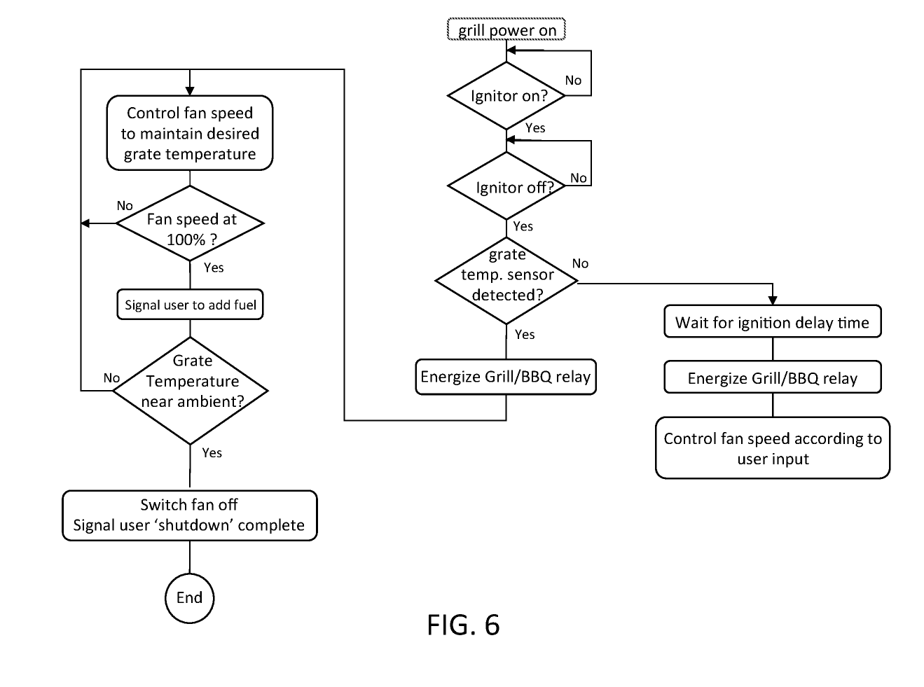

See FIG. 6 for a flow chart of the grill controller operation.

If the access lid of the cooking chamber 4 of the pellet barbecue is closed while operating with the charcoal grill box insert 40, the interior of the cooking chamber can be divided into 3 distinct heat zones (see FIG. 5):

a) The direct heat zone directly above the burning coals

b) A high heat indirect heat zone between the direct heat zone and the exhaust port of the pellet barbecue. High heat because the resulting high temperature combustion gases flow primarily form the direct heat zone toward the exhaust port

c) A low heat indirect heat zone inside the cooking chamber opposite of the exhaust port.

These three zones further increase the versatility of this invention when applied to combined indirect and direct grilling.

The functionality of having a grilling insert box within a pellet barbecue may also be achieved by building a pellet barbecue apparatus with grilling capabilities. A pellet barbecue apparatus with grilling capabilities would not necessarily require a grilling insert box that is attachable and removable from the pellet barbecue apparatus. Rather, essential components and functionality to accommodate grill may be built into the pellet barbecue apparatus. The pellet barbecue apparatus with grilling capabilities would have a built in burn plate for placing coal on top of, and this would be heated by the fire pot. There may be a cooking grate temperature sensor built in to this pellet barbecue apparatus to measure the temperature of the cooking grate. This pellet barbecue apparatus with grilling capabilities would have a pellet barbecue controller that has some or all of the functionality of the described grill insert controller.

Although the present invention has been described in detail with respect to certain embodiments and examples, variations and modifications exist which are within the scope of the present invention as defined in the following claims.

What is claimed is:

1. A grilling enabled pellet barbecue assembly comprising:
a pellet hopper;
a fire pot;
a motorized auger for moving a pellet from said pellet hopper to said fire pot;
a cooking chamber above said fire pot;
an electric combustion fan for blowing air through an air channel to said fire pot at varying speeds;
an electrically heated igniter for igniting said pellet;
a cooking grate within said cooking chamber;
a grill box insert above said fire pot and below said cooking grate, wherein said grill box insert is open at the top, with an opening at the bottom for placement directly over said fire pot;
a burn plate inside said grill box insert for placing charcoal on top of;
a pellet barbecue controller for controlling said electric combustion fan and said electrically heated igniter;
and a grill insert controller comprising of a computer logic, relay switch, power switch, and user input device, wherein said grill insert controller monitors said electrically heated igniter, disrupts power to said pellet barbecue controller and directly controls said electric combustion fan.

2. The grilling enabled pellet barbecue assembly of claim 1 wherein said burn plate inside the grill box insert has openings that increase in size with distance from the center of said opening at the bottom.

3. The grilling enabled pellet barbecue assembly of claim 1 further comprising of a cooking grate temperature sensor for detecting the temperature near the cooking grate.

4. The grilling enabled pellet barbecue assembly of claim 3 wherein said grill insert controller automatically adjusts speed of said electric combustion fan to maintain a specific temperature level by said cooking grate temperature sensor.

5. The grilling enabled pellet barbecue assembly of claim 4 wherein said user input device is a temperature setting.

6. The grilling enabled pellet barbecue assembly of claim 1 wherein said burn plate is comprised of vanes.

7. The grilling enabled pellet barbecue assembly of claim 1 wherein said disruption of power to said pellet barbecue controller occurs when said electrically heated igniter is stopped upon detection of pellet ignition.

8. A grilling enabled pellet barbecue assembly comprising:
a pellet hopper;
a fire pot;
a motorized auger for moving a pellet from said pellet hopper to said fire pot;
a cooking chamber above said fire pot;
an electric combustion fan for blowing air through an air channel to said fire pot at varying speeds;
an electrically heated igniter for igniting said pellet;
a cooking grate within said cooking chamber;
a burn plate above said fire pot and below said cooking grate for placing charcoal on top of;
and a pellet barbecue controller for controlling said electric combustion fan and said electrically heated igniter.

9. The grilling enabled pellet barbecue assembly of claim 8 wherein said burn plate has openings that increase in size with distance from said fire pot.

10. The grilling enabled pellet barbecue assembly of claim 8 further comprising of a cooking grate temperature sensor for detecting the temperature near the cooking grate.

11. The grilling enabled pellet barbecue assembly of claim 10 wherein said pellet barbecue controller automatically adjusts speed of said electric combustion fan to maintain a specific temperature level by said cooking grate temperature sensor.

12. The grilling enabled pellet barbecue assembly of claim 11 further comprising of a user input device for setting a desired temperature.

13. The grilling enabled pellet barbecue assembly of claim 8 wherein said burn plate is comprised of vanes.
